(19) United States
(12) Patent Application Publication
(10) Pub. No.: US 2011/0145518 A1
(43) Pub. Date: Jun. 16, 2011

(54) Systems and methods for using pre-computed parameters to execute processes represented by workflow models

(75) Inventors: Sören Balko, Weinheim (DE); Thomas Hettel, Brisbane (AU)

(73) Assignee: SAP AG

(21) Appl. No.: 12/654,104

(22) Filed: Dec. 10, 2009

(51) Int. Cl. G06F 9/46; G06F 12/00

(52) U.S. Cl. 711/154; 718/102; 711/E12.001

(57) ABSTRACT

Systems and methods consistent with the invention may include initiating an execution of the business process, the business process being represented by a workflow model that includes a synchronization point, retrieving, from a memory device of the computer system, a pre-computed parameter corresponding to the workflow model, and executing, using a processor of the computer system, the business process by using the pre-computed parameter, wherein the pre-computed parameter represents a configuration of the workflow model in which the synchronization point is activated.

### BACKGROUND

1. Relevant Field

Systems and methods consistent with the present invention generally relate to the management of data corresponding to workflow models. More particularly, systems and methods consistent with the invention relate to using pre-computed parameters to execute processes represented by workflow models.

2. Background Information

Businesses and other organizations generate and/or receive a variety of data items and electronic information (broadly referred to hereafter as “business data”) during the course of their operation. The business data may be generated and/or received from various entities located in different regions and/or countries. To organize and manage operations of the organization, the organization may use various modeling languages to generate workflow models describing task routing and activity orchestration within a particular business process executed by the organization. These workflow models may graphically represent activities or tasks of business processes that assist non-technical and technical professionals in the implementation and execution of those processes. For example, a workflow model may include sequence connectors (referred to hereafter as “branches”) semantically denoting the control flow according to which particular tasks or activities may be executed. Parallel branches may indicate the concurrent execution of tasks and the merging of multiple branches at a single point in the workflow model may represent a synchronization point.

Synchronization points may be represented by an exclusive gateway (referred to hereafter as XOR join gateway), an inclusive data-based gateway (referred to hereafter as “OR-join”), and an AND join, and may be used where two or more branches are combined into a single branch based on synchronization and/or activation of the gateway. An XOR join gateway passes any token it receives on its inbound branch to its outbound branch. For example, FIG. 1 illustrates a workflow model 100, in which inbound branches 102 and 104 merge together at a gateway or synchronization point 106 connected to an outgoing branch 108. Inbound branch 102 may represent successful completion of a task 110 and inbound branch 104 may represent successful completion of a task 112.

Synchronization point 106 may be an OR-join and tasks 110 and 112 may represent two concurrent business processes, sub-steps within a business process, or sub-processes, such as, for example, packaging of two different customer orders that need to be shipped. Outgoing branch 108 may represent a joint successor step for inbound branches 102 and 104. Tasks 110 and 112 may be executed concurrently or may be executed at different times, and a completion of one of the tasks may be indicated by receipt of a token at synchronization point 106. For example, upon completion of task 110, synchronization point 106 may receive a token 114. Depending on the type of gateway being used to implement synchronization point 106, receipt of the token 114 may trigger an inspection of branch 104 to determine the progress of task 112 or token 114 may simply be passed on to branch 108 without inspection. Based on various business rules, synchronization point 106 may either activate after receipt of a token from inbound branch 102 or may activate without waiting for task 112 to complete when it may be determined that a token may never arrive at, for example, inbound branch 104. For example, the requested customer order in task 112 may not be available in inventory, and synchronization point 106 may be activated based on a prediction that an additional token may not be received on inbound branch 104. Even a non-successful completion of a task may pass a token to an outbound branch 108. For example, there may be a decision gateway in front of task 112 (not shown) that may check whether or not the requested customer order can be fulfilled from stock. The token may still be passed on to outbound branch 108 even if it is determined that the order cannot be fulfilled, and the token may be re-directed to a different process that may indicate replenishment of the requested order. The activation may ensure shipment of the customer order packaged with respect to inbound branch 102. Thus, an OR-join may be synchronized and/or activated after ensuring that there is at least one token or flow on any of the inbound branches and after ensuring that no token or flow may ever reach an empty inbound branch. An empty inbound branch may indicate a branch that may not include a token at a point in time when the inbound branch is inspected.

Conventional systems perform such resource intensive synchronizations and evaluations by processing workflow models in run-time, which may lead to delays in execution of business processes. This may be caused due to inspection of upstream process fragments for each inbound branch and conventional systems may complete inspections in O(N²) time for each operator, where O(N²) may represent an exponential runtime complexity and N may represent a number of inbound branches of a particular gateway. Further, an increase in an organization's business operations may result in the use of complex workflow models that may require the performance of complex computations at run-time.

In view of the foregoing, it is desirable to provide methods and systems for reducing the time and computations required to process workflow models for the purpose of efficiently evaluating OR join gateways. For example, there is a need for improved methods and systems for processing of workflow models more efficiently and by using less resource intensive techniques.

### SUMMARY

In accordance with one embodiment of the invention, a method for executing a business process is provided. The method includes initiating an execution of the business process, the business process being represented by a workflow model that includes a synchronization point; retrieving, from a memory device of the computer system, a pre-computed parameter corresponding to the workflow model; and executing, using a processor of the computer system, the business process by using the pre-computed parameter, wherein the pre-computed parameter represents a configuration of the workflow model in which the synchronization point is activated.

In accordance with another embodiment of the present invention, there is provided a computer-readable storage medium including instructions which, when executed on a processor, cause the processor to perform a method of executing a business process. The method comprises initiating an execution of the business process, the business process being represented by a workflow model that includes a synchronization point; retrieving a pre-computed parameter corresponding to the workflow model; and executing the business process by using the pre-computed parameter, wherein the pre-computed parameter represents a configuration of the workflow model in which the synchronization point is activated.

Consistent with another embodiment of the present invention, there is provided a system for executing a business process. The system comprises a memory device having instructions; and a processor executing the instructions for initiating an execution of the business process, the business process being represented by a workflow model that includes a synchronization point; retrieving a pre-computed parameter corresponding to the workflow model; and executing the business process by using the pre-computed parameter, wherein the pre-computed parameter represents a configuration of the workflow model in which the synchronization point is activated.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 illustrates a conventional workflow model;

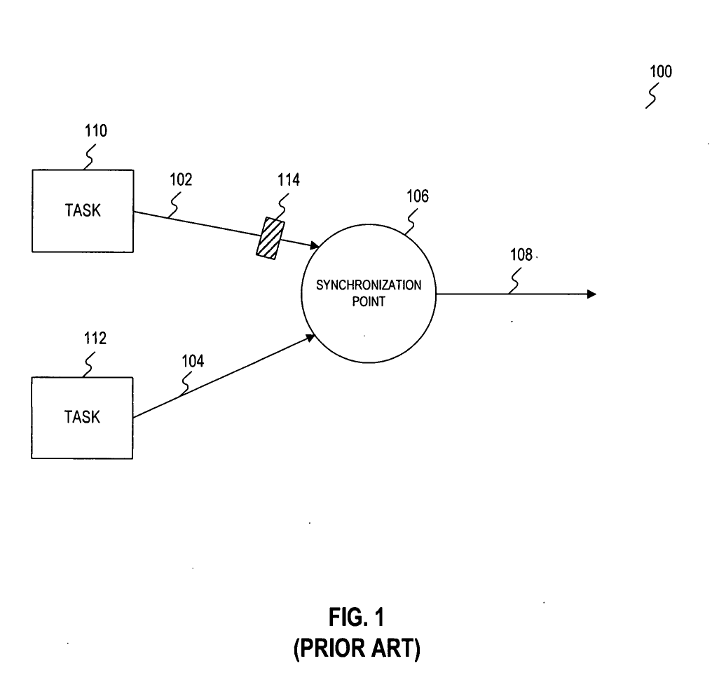

FIG. 2 illustrates an exemplary layered system of an organization, consistent with the present invention;

FIG. 3 illustrates an exemplary system for performing optimized run-time execution of a business process represented by a workflow model, consistent with the present invention;

FIG. 4A illustrates an exemplary workflow model, consistent with the invention;

FIG. 4B illustrates an exemplary run-time representation corresponding to an exemplary workflow model, consistent with the invention;

FIG. 5 illustrates a flowchart illustrating an exemplary process 500 for generating a run-time representation of an exemplary workflow model, consistent with the present invention; and

FIG. 6 illustrates a flowchart illustrating an exemplary process 600 for executing a business process represented by a workflow model, consistent with the present invention.

### DETAILED DESCRIPTION

The following detailed description refers to the accompanying drawings. Wherever possible, the same reference numbers are used in the drawings and in the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering, or adding steps to the disclosed methods. Accordingly, the following detailed description does not limit the invention. Instead, the proper scope of the invention is defined by the appended claims.

Systems and methods consistent with the invention generally relate to optimizing the processing of workflow models that are then used by systems and engines run by organizations to monitor, execute, and/or govern their business processes. The workflow models may be programmed and modeled in accordance with a notation similar to Business Process Modeling Notation (BPMN), which may include flow objects, connecting objects, swim lanes, artifacts, and other attributes known to those skilled in the art. Exemplary processing engines that may be used in systems consistent with the invention include those offered by SAP AG, such as SAP NetWeaver Business Process Management (SAP NetWeaver BPM). SAP NetWeaver BPM may efficiently model, execute, and monitor business processes based on a common process model. SAP NetWeaver BPM may be used to orchestrate process steps, define business rules and exceptions, model process flows using various business process modeling notations, execute process models efficiently, monitor business processes, and/or support interaction with running processes via personalized user interfaces or interactive forms.

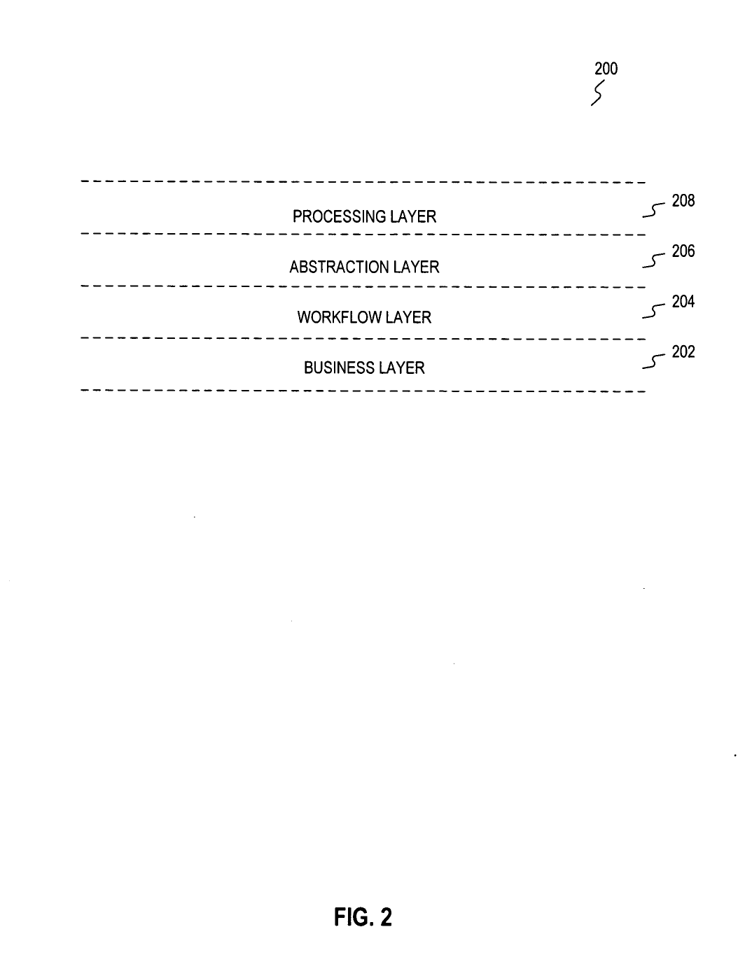

For example, as shown in FIG. 2, an exemplary organization 200 may be divided into multiple layers based on their operations. Organization 200 may have a business layer 202 that may depict business operations of an organization 200. These business operations may include implementation of communication systems, operation of manufacturing plants, arrangement of supplies for the manufacturing process, shipping of manufactured products, sales and marketing of these products, and/or additional operations. Organization 200 may also include workflow layer 204 that may include various workflow models representing the business operations being run in business layer 202. The workflow models may add flexibility to business operations by allowing customers to flexibly orchestrate operations from underlying platforms in a customized manner. The sequence and execution of business operations in business layer 202 may thus be based on the workflow models included in workflow layer 204.

Organization 200 may also include an abstraction layer 206 that may depict the business data that is abstracted from systems run in business layer 202. The abstracted business data may be raw data that has not yet been manipulated or processed, but which may be processed in a processing layer 208 of organization 200. Processing layer 208 may include various components, implemented in either hardware and/or software, and may be used to implement a processing engine.

Processing layer 208 may be used to correlate the business data with the workflow models included in workflow layer 204. The business data may be processed and correlated to ensure that the business operations running in business layer 202 are being executed consistent with the workflow models. By using processing layer 208, a user in organization 200 may use processed business data to monitor and deduce information regarding business operations of organization 200. As is described in further detail below, processing layer 208 may include pre-computed parameters corresponding to workflow models included in workflow layer 204. These parameters may be used to ensure efficient execution of business operations with respect to the workflow models of organization 200.

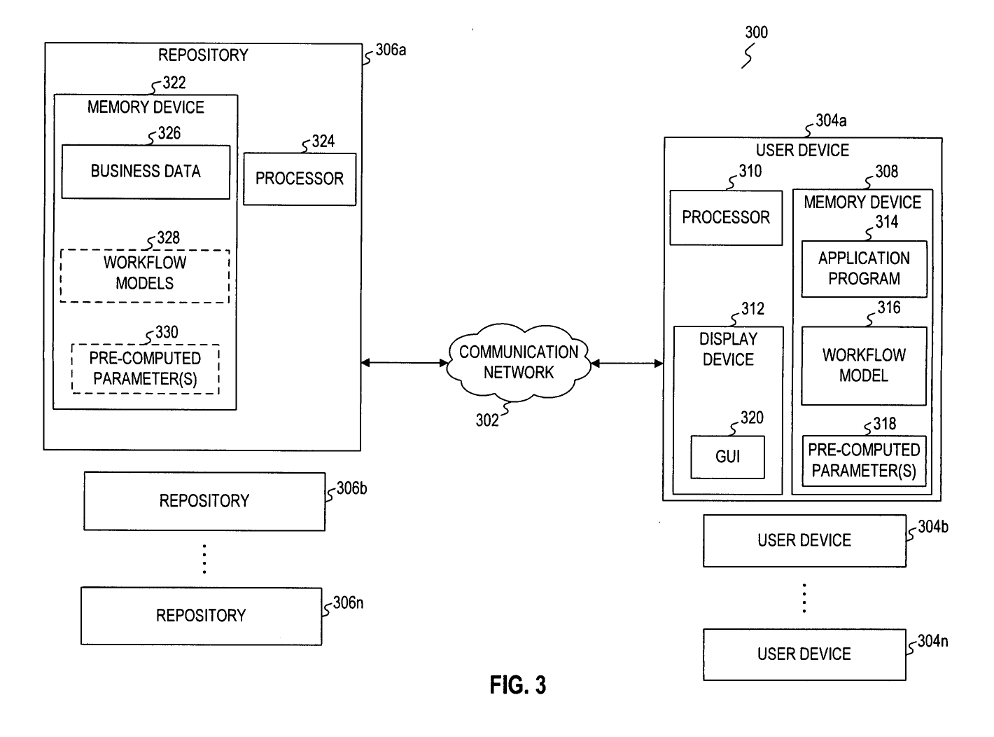

FIG. 3 is a system 300 for performing optimized run-time execution of a business process represented by a workflow model that may be implemented in, for example, business organization 200. As shown in FIG. 3, system 300 may include a communication network 302 that facilitates communication between a plurality of nodes 304a-n and 306a-n. Communication network 302 may include one or more network types, such as a wide-area network (WAN), a local-area network (LAN), or the Internet. Communication network 302 may operate by wireline and/or wireless techniques and may use transmission control protocol/internet protocol (“TCP/IP”) or any other appropriate protocol to facilitate communication between nodes 304a-n and 306a-n of system 300. Network connections between the nodes of system 300 may be established via Ethernet, telephone line, cellular channels, or other transmission media.

Each node of system 300 may comprise a combination of one or more application programs and one or more hardware components. For example, application programs may include software modules, sequences of instructions, routines, data structures, display interfaces, and other types of structures that execute operations of the present invention. Further, hardware components may include a combination of Central Processing Units (CPUs), buses, memory devices, storage units, data processors, input devices, output devices, network interface devices, and other types of components that will become apparent to those skilled in the art.

Consistent with an embodiment of the present invention, nodes 304a-n and 306a-n of system 300 may be respectively implemented by using user devices and repositories. User device 304a may be an appropriate device for sending, receiving, processing, and presenting data. For example, user device 304a may be implemented using a variety of types of computing devices, such as a personal computers, workstations, mainframe computers, notebooks, global positioning devices, and/or handheld devices such as cellular phones and personal digital assistants.

As is illustrated in FIG. 3, user device 304a may include a memory device 308, a processor 310, and a display device 312. Memory device 308 may be used to store instructions, such as an application program 314, which may be executed by processor 310 to cause user device 304a to implement a plurality of operations. Memory device 308 may also store a workflow model 316 and pre-computed parameter(s) 318 that represent a run-time representation of workflow model 316. Application program 314 may be used to implement a business process execution engine, such as SAP NetWeaver BPM, and processor 210 may cause user device 304a to perform business operations represented by workflow model 316. Display device 312 may be used to implement a graphical user interface (GUI) 320 to allow a user of user device 304a to interface with at least a portion of system 200. For example, graphical user interface 320 may display workflow model 316, and a user may use user device 304a to modify the workflow model. User device 304a may also include additional components such as input and output devices (not shown), and user devices 304b-n may also include memory devices, processors, and application programs as described above with respect to user device 304a.

User devices 304a-n may communicate with repositories 306a-n via communication network 302. Repositories 306a-n may be used to classify, manage, and store data. Repositories 306a-n may be located in different regions and may comprise a database management system. As shown in FIG. 3, repository 306a may include a memory device 322 and a processor 324. Memory device 322 may store business data 326 that may be received during execution of business processes of an organization. Memory device 322 may also include workflow models 328 and corresponding pre-computed parameters 330 that may be retrieved by user devices 304a-n. For instance, user devices 304a-n may retrieve models 328 and parameters 330 if user devices 304a-n do not store them to conserve storage capacity. User devices 304a-n may also retrieve workflow models 328 and corresponding pre-computed parameters 330 when the models and corresponding parameters stored in user devices 304a-n become corrupt or need to be updated.

Memory device 322 may also include application programs (not shown) that may be executed on processor 324 for management, maintenance, and retrieval of data stored in memory device 322. Repositories 306b-n may also include memory devices, application programs, and processors. Communication between user devices 304a-n and repositories 306a-n may include sending data, such as requests and queries to repository 306a, and receiving data, such as an extracted workflow models 328 and/or pre-computed parameters 330, from repository 306a.

Although the exemplary embodiment of system 300 is described as having particular components arranged in a particular manner, one skilled in the art will appreciate that system 300 may include additional or fewer components that may be arranged differently. For example, system 300 may be implemented with only a single user device 304a and/or a single repository 306a. Further, user devices 304a-n and repositories 306a-n may include additional processors and/or memory devices or user device 304a may be implemented as a standalone station. System 300 may also be implemented in a client/server arrangement, and the server may include hardware and software components. Further, system 300 may be implemented with fewer user devices and/or repositories than is illustrated in FIG. 3. Memory devices 308 and 322 may include all forms computer-readable storage mediums, such as non-volatile or volatile memories, including, by way of example, semiconductor memory devices, such as EPROM, RAM, ROM, DRAM, EEPROM, and flash memory devices; magnetic disks such as internal hard disks and removable disks; magneto-optical disks; and CD-ROM disks.

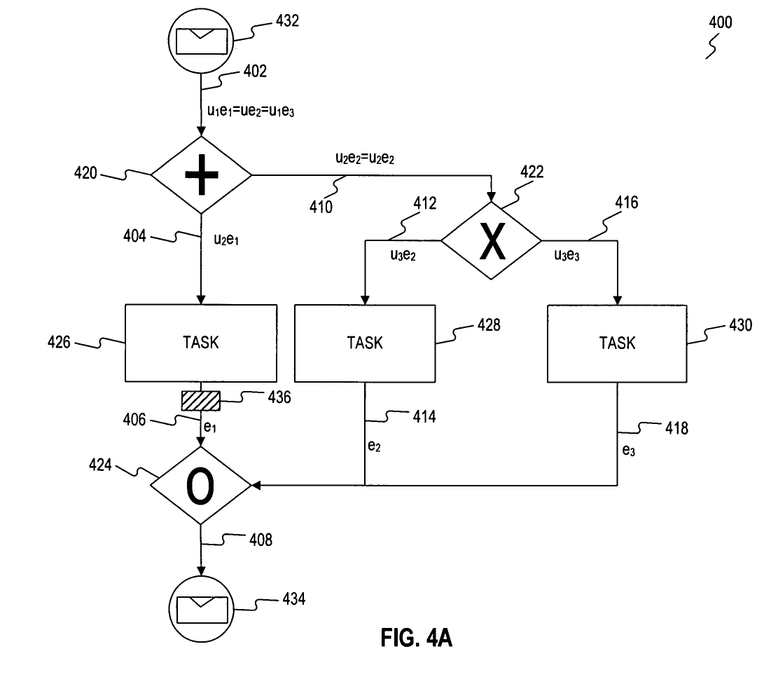

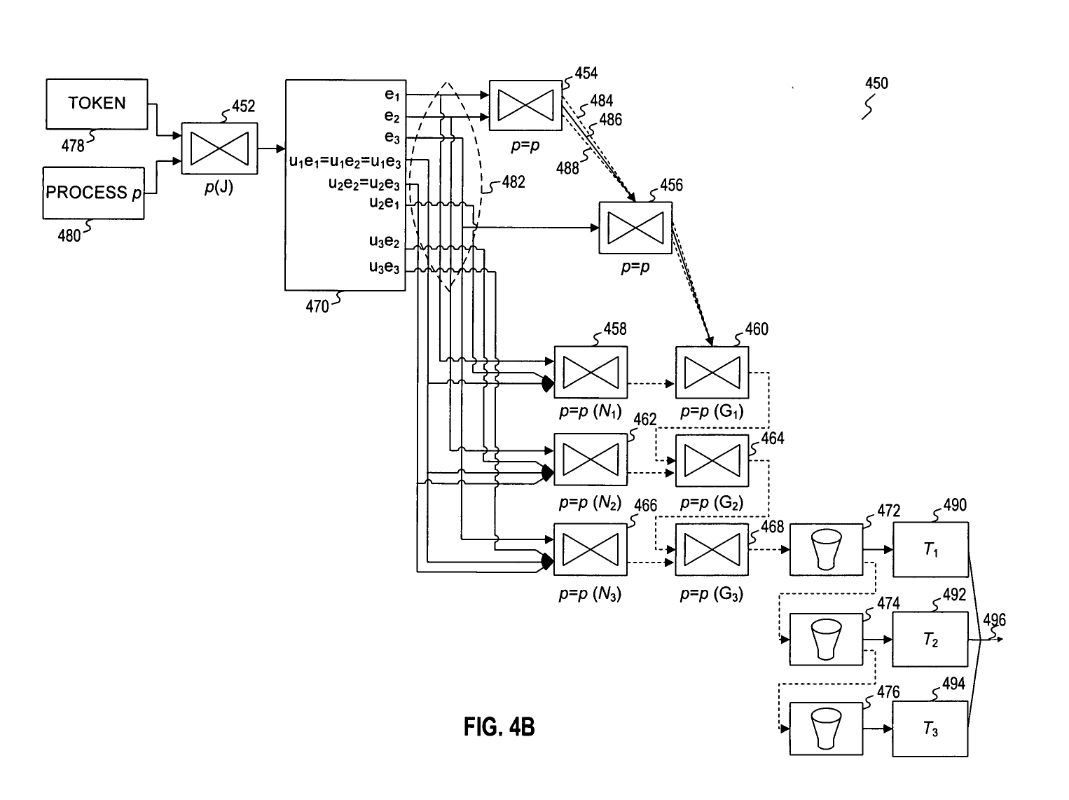

As is described in further detail below with respect to FIGS. 4A and 4B, pre-computed parameter(s) 318 and pre-computed parameters 330 may be stored in memory devices of system 300 before system 300 implements a business operation. The pre-computed parameters may be based on a design-time analysis of their corresponding workflow models. For example, at design time, workflow model 316 may be generated based on various business rules of an organization. Workflow model 316 may include a number of artifacts including OR-joins, XOR joins, branches, AND splits, and other components that may be known at design time. Generating pre-computed parameters 318 corresponding to workflow model 316 may include generating a list of event-condition-action (ECA) rules corresponding to each component of workflow model 316.

As is apparent to one of skill in the art, an event part of an ECA rule may specify a signal that may trigger an invocation of a corresponding rule, and the condition part may indicate a logical test, that if satisfied or evaluated to be true, may cause the action to be carried. Carrying out the action of an ECA rules may trigger the execution of additional rules that may lead to the evaluation of additional conditions, and the execution of additional actions. For example, an ECA rule for an AND-join gateway that may synchronize two inbound branches may be generated by defining a pseudo code syntax as follows:

rule ANDjoin {

If (exists Process p and exists Token t1 and

exists Token t2 (t1.owner=p and t2.owner=p and
t1.position=<at inbound
branch1> and t2.position=<at inbound branch2>))

Execute {t1.position=<at outbound branch>; delete t2;}
}

The condition of the rules may correspond to status variables and their attributes that denote the current state of a process indicated by workflow model 316. A state of a process may be based on a number of tokens and their corresponding positions in workflow model 316. Pre-computed parameter(s) 318 may be obtained by analyzing the conditions and may represent the trigger networks. A trigger network may be a graph based on the RETE algorithm that may be used for processing event-condition-action rules in a transactional manner.

As is apparent to one of skill in the art, the RETE algorithm is an efficient pattern matching algorithm for implementing production rule systems, and may be used to generate a RETE-graph. A system implementing a RETE-graph may build a network of nodes, where each node may correspond to a pattern occurring in a condition of a rule. The path from the root node to a leaf node may define a complete rule and each node may include a memory of facts that may satisfy the pattern. When a fact or combination of facts causes patterns for a given rule to be satisfied, a leaf node may be reached and a corresponding rule is triggered. A RETE-graph may be a data structure including operator nodes and may describe the order in which the graph may be traversed in order to check a condition. The trigger network may be a variant of a RETE-graph and may differ from a RETE-graph such that states may be preserved over successive transactions in a trigger network and conditions may be conceptually expressed in trigger network. Thus, pre-computed parameter(s) 318 may be generated by mapping workflow model 316 onto trigger networks that may be conceptually represented by ECA rules. Trigger networks represented by pre-computed parameters 318 may represent a run-time representation of workflow model 316.

Consistent with an embodiment of the invention, processor 310 may execute application program 312 to cause user device 304a to perform one or more tasks or activities of a business operation in accordance with workflow model 316. During execution of application program 312, processor 310 searches for pre-computed parameter(s) 318 in memory device 308. Since pre-computed parameter(s) 318 may be stored in memory device 308 at design-time, processor 310 enables user device 304a to continue executing tasks and business processes in accordance with the sequence identified in workflow model 316 without performing resource intensive computations to perform run-time synchronization of merging branches.

Alternatively, during execution of application program 312, processor 310 may determine that there are no pre-computed parameters in memory device 308. If such a determination is made, user device 304a may send a request or query to repository 306a, via communication network 302, to retrieve pre-computed parameters 330 to continue execution of business tasks or operations using user device 304a. Similarly, user device 304a may retrieve workflow models 328 from repository 306a when workflow model 316 is not stored or becomes corrupt.

User device 304a may continue to receive and/or generate business data during execution of business operations. This business data may be temporarily stored in memory device 308 and may be sent to repository 306a via communication network 302 for permanent storage as business data 326. Alternatively, the business data being received and/or generated during execution of business operations by user device 304a may be directly sent to repository 306a as it is being received and/or generated.

Referring now to FIG. 4A, an exemplary workflow model 400 representing a business process being executed by an organization is illustrated. Workflow model 400 may be generated by employees of the organization based on business rules and/or requirements. The generation of workflow model 400 may be during design-time phase, when a system is being designed to implement the business process, and may be stored in a memory device of the system after generation. For example, workflow model 400 may correspond to workflow model 316 stored in memory device 308 of system 300.

As is illustrated in FIG. 4A, workflow model includes branches or edges 402, 404, 406, 408, 410, 412, 414, 416, and 418, that may connect an AND-split gateway 420, an XOR split gateway 422, and an OR-join gateway 424. Tasks 426, 428, and/or 430 may need to be performed to execute the business process represented by workflow model 400. Further, workflow model 400 may receive inbound message 432 to initiate execution of the business process, and may generate an outbound message 434 when execution of the business process is complete, which may be indicated by synchronization of OR-join gateway 424.

With respect to OR-join gateway 424, branch 406 may be a first inbound branch e₁, branch 414 may be a second inbound branch e₂, and branch 418 may be a third inbound branch e₃. An OR-join gateway may be synchronized and/or activated based on exponential token configurations represented by the equation 2^{N}−1 possible combinations of activated inbound branches, where N represents the number of inbound branches with respect to the OR-join gateway. For example, OR-join gateway 424 may be synchronized based on at least seven different token configurations because it has three inbound branches 406(e₁), 414(e₂), and 418(e₃). These combinations may include seven token configurations including e₁, e₂, e₃, the combination of e₁ and e₂, the combination of e₁ and e₃, the combination of e₂ and e₃, and the combination of e₁, e₂, and e₃.

Branches 402, 404, 410, 412, and 416 may represent upstream states or join upstream states of inbound branches 406(e₁), 414(e₂), and 418(e₃). For example, branch 404 may represent upstream state u₂e₁ of first inbound branch 406, branch 412 may represent upstream state u₃e₂ of second inbound branch 414, and branch 416 may represent upstream state u₃e₃ of third inbound branch 418. Similarly, branch 402 may represent joint upstream state u₁e₁=u₁e₂=u₁e₃ of all three inbound branches 406, 414, and 418, and branch 410 may represent joint upstream state u₂e₂=u₂e₃ of first inbound branch 406 and second inbound branch 414. The execution of tasks 426, 428, and 430 may be based on the positions of tokens (not shown) at various branches such that the states being represented by the branches may depend on the position of a particular token on a particular branch. Specifically, a token status variable may hold a branch label, for example branch 406, as an attribute value that may be evaluated in an ECA rule.

The business process represented by workflow model 400 may complete execution when OR-join gateway 424 is triggered, activated, and synchronizes the inbound token(s). This may result in outbound message 434 being sent on outbound branch 408. Outbound message 434 is not passed back to branch 408, but is passed to a different business system that may, for example, have triggered the process that caused the generation of outbound message 434. OR-join 424 may synchronize when there is at least one token on any one of inbound branches 406, 414, and 418 and there is no possibility that a token may reach OR-join 424 from one of the inbound branches after it is determined that one of the inbound branches does not have any token. For example, it may be determined that inbound branch 406 includes a token 436 and inbound branches 414 and 418 do not have any token. In addition, it may be determined that no additional token may arrive at OR-join 424 from inbound branches 414 and 418 after it has been determined that there are no tokens on these branches. In order to perform such a determination, upstream branches 402, 410, 412, and 416 may also be checked to ensure that no additional token may arrive. These determinations may be made by mapping the workflow model to trigger networks to determine the upstream states of each inbound branch and the trigger network is constructed according to the determined states. Synchronization may be inhibited if, for example, a token may be determined to reside on an upstream connector or an empty inbound connector.

For example, FIG. 4B illustrates a run-time representation in the form of a trigger network 450 corresponding to workflow model 400. As is illustrated in FIG. 4B, trigger network 450 may include join operators 452, 454, 456, 458, 460, 462, 464, 466, and 468, a switch operator 470, and filter operators 472, 474, and 476. Trigger network 450 may be stored as a pre-computed parameter that may correspond to execution of a business process represented by workflow model 400. For example, trigger network 450 may be stored as a pre-computed parameter that represents a run-time execution of a process 480 (“p”) that may begin execution when a token 478 may be inputted into join operator 452.

Join operators 452, 454, 456, 458, 460, 462, 464, 466, and 468 may represent instances of a process corresponding to a token that may be inputted into a particular join operator that may match tuples of state variables or combinations of token state variable instances based on a condition. Join operators may pair of all instances of token objects fitting to all instances of process instance objects and may check whether the token tuples received on both inputs refer to the same process instance. Labels p(J), p=p, p=p(N), and p=p(G) may be attached to join operators to classify the join operators according to their function. For example, join operator 452 is labeled p(J), where p(J) may indicate a function of pairing up each token to a corresponding process instance for join operator 452. Join operators 454 and 456 may be labeled p=p to combine the tokens paired by join operator 452 to a tuple which reside on inbound branches 406, 414, and 418 of.

Join operators 458, 462, and 466, labeled as p=p(N), may determine whether there is a token on one of the empty upstream branches that may arrive on, for example, inbound branches 406, 414, and/or 418. Join operators 460, 464, and 468 may be labeled as p=p(g) and may inhibit triggering or synchronization if it is determined that a token may arrive at one the corresponding join operators.

Join operators may represent fragments of a complex rule condition. For example, token instances T1 and T2 of token 478 corresponding to events may be received, and to perform joins, join operator 452 may maintain an internal matching table of instances receives and matching pair of object corresponding to process 480. Join operator 452 may include a table (not shown) including a left column containing identification of “Instance” objects and a right column identifying “Token” objects. A pair of instance and token objects (I, T1) and (I, T2) may be a result of the evaluation performed by join operator 452.

Switch operator 470 may receive the pairs from join operator 452 and may send the pairs down to one of multiple output paths 482 based on positions of tokens on particular branches in a corresponding workflow model. The switch operator may account for different token configurations and different states of a particular workflow model that may be based on token positions. For example, as is illustrated in FIG. 4B, output paths 482 may include paths labeled e₁, e₂, e₃, u₁e₁=u₁e₂=u₁e₃, u₂e₂=u₂e₃, u₂e₁, u₃e₂, and u₃e₃ that may respectively correspond to branches 406, 414, 418, 402, 410, 404, 412, and 416 of workflow model 400. Switch operator 470 may output one or more tokens on output paths 482 and to join operators 454, 456, 458, 462, and 468 based on the positions of tokens determined by evaluating pairs received by switch operator 470.

Join operators 454, 456, 458, 460, 462, 464, 466, and 468 may process the received token instances similar to the processing explained above with respect to join operator 452 and may output one or more token instance pairs to the next component in trigger network 450. For example, join operator 454 may output one or two tokens along paths 484, 486, and 488. These tokens may be received by join operator 456 that may further output one, two, or three tokens to join operator 460. Similarly, an output of join operator 458 may be connected to an input of join operator 460, an output of join operator 462 may be connected to an input of join operator 464, and an output of join operator 466 may be connected to an input of join operator 468. Further, an output of join operator 468 may be connected to filter operator 472.

Filter operators 472, 474, and 476 may determine whether the inbound branches of a synchronization point in a corresponding workflow model may be receiving one, two, or three tokens, and accordingly none, one, or two tokens may be deleted and a single token may be outputted on an outbound branch corresponding to the synchronization point. For example, if three tokens may be included in inbound branches 406, 414, and 418 of workflow model 400, filter operators 472, 474, and 476 may check the number of tokens that may qualify to be jointly synchronizes. Filter operator 472 may pass on a tuple if there is just one token, filter operator 474 may pass on a tuple if there are two tokens, and filter operator 476 may pass on a tuple if there are three tokens. As is shown in FIG. 4B, filter operators 472, 474, and 476 may have true exits (indicated by solid lines) and false exits (indicated by dashed lines) such that if a tuple contains more than a single token, filter operator 472 may pass the extra token thru its false exit to filter 474.

An evaluation of trigger network 450 may ensure that the conditions for activating, triggering, or activating synchronization point 424 may be met during the evaluation. Trigger network 450 may include target nodes 490, 492, and 494 that may represent synchronization of one, two, or three token cases, respectively. Each target note may be associated with a corresponding action script that may perform the synchronization by deleting all but one token which is placed onto branch 408 of workflow model 450. Once the evaluation of trigger network 450 is performed, parameters corresponding to the evaluation of trigger network 450, and indicating token configurations that may be required to perform process 400 may be generated and stored. Trigger network 450 may be used to express and evaluate exponentially many token combinations, that may be required to synchronize a particular synchronization point of a workflow model, in a linear manner with respect to the number of inbound branches of, for example, an OR-join. This linear manner may reduce the runtime complexity to O(N) for each operator, where O(N) may represent a linear runtime complexity and N may represent a number of inbound branches.

Parameters representing trigger network 450 may be stored and used during execution of a business process to enable a system of a business organization to perform the business process without performing run-time resource intensive computations to determine token configurations that may synchronize, trigger, or activate synchronization points in a workflow model representing the business process.

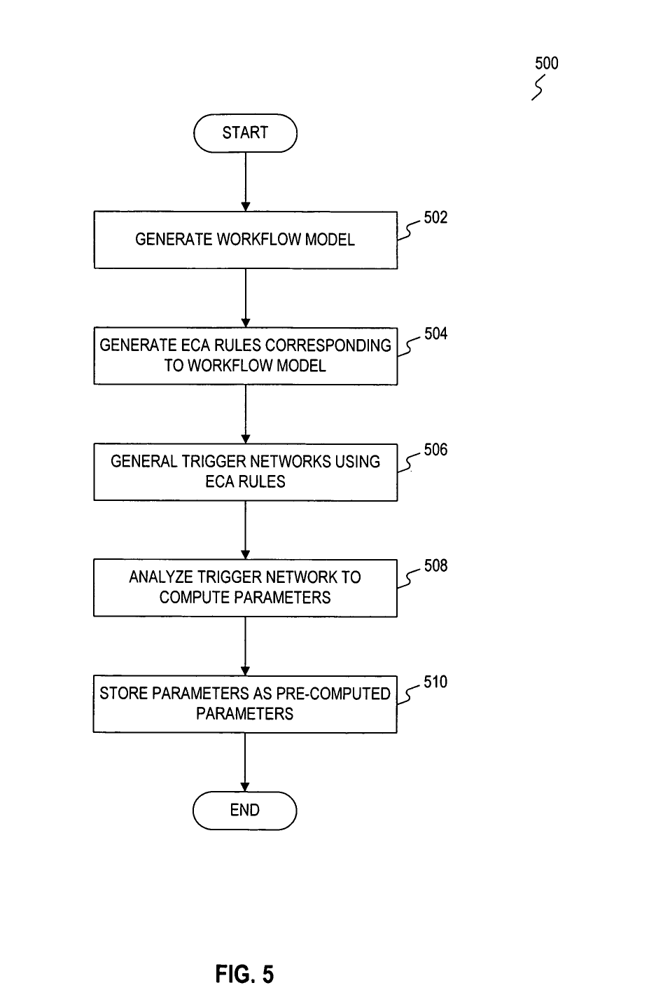

FIG. 5 is a flow diagram of a process 500 for generating a run-time representation of a workflow model, consistent with the invention. Process 500 may be implemented at design-time of system 300, and by using user device 304a or other systems known to those skilled in the art. The process may begin in step 502 where a workflow model may be generated. The workflow model may correspond to workflow model 400 and may represent a business operation of an organization. The workflow model may include a plurality of tasks and/or activities that may need to be performed to complete the business operation and may be generated by one or more employees of the organization based on business rules and/or requirements. Next, in step 504, ECA rules corresponding to the workflow model may be generated.

In step 506, trigger networks may be generated based on the ECA rules generated in step 504. One of the trigger networks may correspond to trigger network 450, and may represent the exponentially many token combinations of workflow model in a linear manner. The trigger network may include various operators, such as a source node, a target node, a filter operator, a switch operator, and a join operator. The trigger network may represent a run-time model corresponding to the workflow model generated in step 502 and may be stored as pre-computed parameters (step 508). The pre-computed parameter may be stored in, for example, memory device 308 and/or memory device 322 of system 300. These parameters may represent the various states of branches and configurations of tokens indicating the state in which a particular synchronization point of the workflow model is activated, triggered, and/or synchronized. For example, a computed parameter may indicate a particular instant of a workflow model in which an OR-join of the workflow model is activated such that a token is outputted along an outbound branch connected to the OR-join.

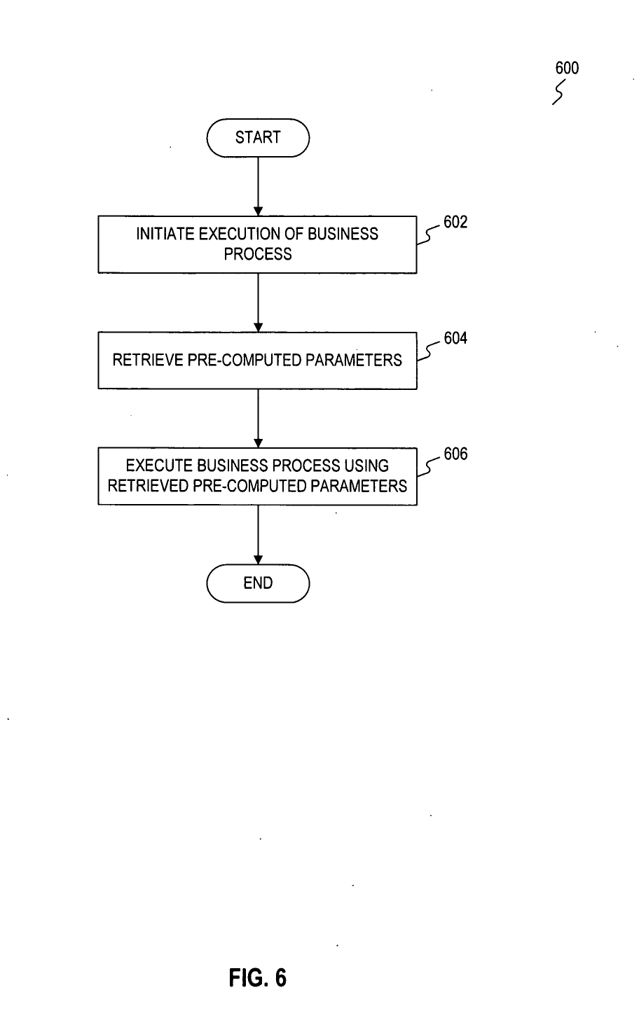

FIG. 6 is a flow diagram of a process 600 for executing a business process represented by a workflow model, consistent with the invention. Process 600 may be implemented at run-time of system 300, and by using user device 304a or other systems known to those of skill in the art. The process may begin in step 602 where execution of a business process may be initiated. The business process may be represented by a workflow model and may include a plurality of tasks and/or activities. Next, in step 604, pre-computed parameters representing a run-time representation corresponding to the workflow model may be retrieved. The pre-computed parameters may be retrieved by searching for the parameters in a storage device of an organization executing the business process. If the search does not result in retrieval of the pre-computed parameters or if the search results in retrieval of corrupted pre-computed parameters, an error message may be displayed and/or a request may be sent to additional repositories or memory devices of the organization. These pre-computed parameters may represent a mapping between a trigger network and a workflow model, and may represent various states in which synchronization points of the workflow model may be activated and/or triggered.

The process may move to step 606, where the business process represented by the workflow model may be executed and the process may end. The business process may be executed by a system of an organization and without performing run-time computations corresponding to the workflow model. For example, the business process may be executed by using the pre-computed parameters and independent of retrieval of and/or without referring to a workflow model representing the business model. Such an execution may reduce the need to perform resource-intensive computations to process and synchronize the synchronization points in the workflow model during run-time execution of the business process.

The foregoing description of possible implementations consistent with the present invention does not represent a comprehensive list of all such implementations or all variations of the implementations described. The description of only some implementations should not be construed as an intent to exclude other implementations. One of ordinary skill in the art will understand how to implement the invention in the appended claims in many other ways, using equivalents and alternatives that do not depart from the scope of the following claims.

The systems and methods disclosed herein may be embodied in various forms including, for example, a data processor, such as a computer that also includes a database. Moreover, the above-noted features and other aspects and principles of the present invention may be implemented in various environments. Such environments and related applications may be specially constructed for performing the various processes and operations according to the invention or they may include a general-purpose computer or computing platform selectively activated or reconfigured by code to provide the necessary functionality. The processes disclosed herein are not inherently related to any particular computer or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Systems and methods consistent with the present invention also include computer readable media that include program instruction or code for performing various computer-implemented operations based on the methods and processes of the invention. The media and program instructions may be those specially designed and constructed for the purposes of the invention, or they may be of the kind well known and available to those having skill in the computer software arts. Examples of program instructions include, for example, machine code, such as produced by a compiler, and files containing a high level code that can be executed by the computer using an interpreter.

The foregoing description of possible implementations consistent with the present invention does not represent a comprehensive list of all such implementations or all variations of the implementations described. The description of only some implementations should not be construed as intent to exclude other implementations. One of ordinary skill in the art will understand how to implement the invention in the appended claims in may other ways, using equivalents and alternatives that do not depart from the scope of the following claims.

What is claimed is:

1. A method, implemented by a computer system, of executing a business process, the method comprising:
initiating an execution of the business process, the business process being represented by a workflow model that includes a synchronization point;
retrieving, from a memory device of the computer system, a pre-computed parameter corresponding to the workflow model; and
executing, using a processor of the computer system, the business process by using the pre-computed parameter, wherein the pre-computed parameter represents a configuration of the workflow model in which the synchronization point is activated.

2. The method of claim 1, further comprising generating, before initiating the execution of the business process, the workflow model by using Business Process Modeling Notation, wherein the synchronization point is an inclusive data-based gateway.

3. The method of claim 1, further comprising:
storing, in the memory device, the workflow model; and
processing the workflow model to generate the pre-computed parameter before initiating the execution of the business process, wherein the
business process is executed independent of retrieval of the workflow model from the memory device during the execution and without using the workflow model to determine the configuration during the execution.

4. The method of claim 1, further comprising generating the workflow model based on a business rule of an organization.

5. The method of claim 1, further comprising:
generating, before initiating the execution of the business process, the workflow model that includes the synchronization point and a plurality of components; and
generating a trigger network representing a run-time representation of the workflow model.

6. The method of claim 5, further comprising storing, in the memory device, the trigger network as the pre-computed parameter.

7. The method of claim 1, wherein the synchronization point is connected to a plurality of inbound branches in the workflow model, wherein the plurality of inbound branches provide one or more tokens to activate the synchronization point.

8. The method of claim 7, wherein the workflow model represents 2^{N}−1 distinct combinations of the one or more tokens, wherein N is a number of the plurality of inbound branches and the exponential configurations are based on the one or more tokens.

9. The method of claim 8, further comprising computing, before initiating the execution of the business process, the pre-computed parameter represented by a trigger network corresponding to the workflow model, the trigger network indicating the distinct combinations in a linear manner.

10. The method of claim 1, further comprising:
generating, before initiating the execution of the business process, a trigger network corresponding to the workflow model; and
determining the configuration in which the synchronization point is activated based on the trigger network.

11. A computer-readable storage medium comprising instructions, which when executed on a processor, cause the processor to perform a method of executing a business process, the method comprising:
initiating an execution of the business process, the business process being represented by a workflow model that includes a synchronization point;
retrieving a pre-computed parameter corresponding to the workflow model; and
executing the business process by using the pre-computed parameter, wherein the pre-computed parameter represents a configuration of the workflow model in which the synchronization point is activated.

12. The computer-readable storage medium of claim 11, wherein the method further comprises:
storing the workflow model in a memory device; and
processing the workflow model to generate the pre-computed parameter before initiating the execution of the business process, wherein the
business process is executed independent of retrieval of the workflow model from the memory device during the execution and without using the workflow model to determine the configuration during the execution.

13. The computer-readable storage medium of claim 11, wherein the method further comprises:
generating, before initiating the execution of the business process, the workflow model that includes the synchronization point and a plurality of components; and
generating a trigger network representing a run-time representation of the trigger network.

14. The computer-readable storage medium of claim 13, wherein the method further comprises storing, in the memory device, the trigger network as the pre-computed parameter.

15. The computer-readable storage medium of claim 11, wherein the synchronization point is connected to a plurality of inbound branches in the workflow model, wherein the plurality of inbound branches provide one or more tokens to activate the synchronization point.

16. The computer-readable storage medium of claim 15, wherein the workflow model represents 2^{N}−1 distinct combinations of the one or more tokens, wherein N is a number of the plurality of inbound branches and the exponential configurations are based on the one or more tokens.

17. The computer-readable storage medium of claim 16, wherein the method further comprises computing, before initiating the execution of the business process, the pre-computed parameter based on a trigger network corresponding to the workflow model, the trigger network indicating the distinct combinations in a linear manner.

18. The computer-readable storage medium of claim 11, wherein the method further comprises:
generating, before initiating the execution of the business process, a trigger network corresponding to the workflow model; and
determining the configuration in which the synchronization point is activated based on the trigger network.

19. A system of executing a business process, comprising:
a memory device having instructions; and
a processor executing the instructions, wherein the instructions include instructions for:
initiating an execution of the business process, the business process being represented by a workflow model that includes a synchronization point;
retrieving a pre-computed parameter corresponding to the workflow model; and
executing the business process by using the pre-computed parameter, wherein the pre-computed parameter represents a configuration of the workflow model in which the synchronization point is activated.

20. The system of claim 19, further comprising a repository storing the pre-computed parameter and the workflow model, wherein the processer retrieves the pre-computed parameter by:
searching the memory device for the pre-computed parameter; and
sending a request to retrieve the pre-computed parameter from the repository when the pre-computed parameter is not stored in the memory device or when the pre-computed parameter stored in the memory device is determined to be corrupt.
